(19) United States
(12) Patent Application Publication
(10) Pub. No.: US 2012/0266599 A1
(43) Pub. Date: Oct. 25, 2012

(54) Heat Exchanger Plate and Evaporator Comprising Same

(76) Inventors: Jurgen Berger, Gerstetten (DE); Peter Ambros, Kusterdingen (DE); Axel Fezer, Ebersbach an der Fils (DE); Jochen Orso, Reutlingen (DE); Harald Necker, Nurtingen (DE)

(21) Appl. No.: 13/502,338

(22) PCT Filed: Oct. 22, 2010
(86) PCT No.: PCT/EP10/06466

§ 371 Date: Jul. 6, 2012

(30) Foreign Application Priority Data
Oct. 23, 2009 (DE) 10 2009 050 482.6

(51) Int. Cl. F28F 3/12; F02B 73/00; F25B 39/02

(52) U.S. Cl. 60/716; 165/168; 62/515

(57) ABSTRACT

The invention relates to a heat exchanger plate for an evaporator;
with a longitudinal axis and a transverse axis, with the transverse axis being disposed perpendicularly or substantially perpendicularly to the longitudinal axis;
with at least one flow channel which extends in the direction of the longitudinal axis of the heat exchanger plate through a heat supply area of the heat exchanger plate and conducts the medium to be evaporated;
with an inlet for the medium to be evaporated, which inlet is in a flow-conducting connection with the at least one flow channel arranged in the direction of the longitudinal axis of the heat exchanger plate, with
a meandering inflow channel being provided in the direction of the longitudinal axis between the inlet and the at least one flow channel arranged in the direction of the longitudinal axis, which inflow channel is in a flow-conducting connection with the inlet and the at least one flow channel, and conducts the medium which flows out of the inlet to the at least one flow channel in an alternating manner along the transverse axis in the direction of the at least one flow channel.

The invention is characterized in that the meandering inflow channel is formed by a plurality of webs which are disposed on the heat exchanger plate or a base plate which forms the bottom or top of the inflow channel and the at least one flow channel arranged in the direction of the longitudinal axis, which webs extend in the direction of the transverse axis, and the inflow channel between the webs is subdivided into individual partial channels by a plurality of plates which extend in the direction of the transverse axis.

The present invention relates to a heat exchanger plate for an evaporator and an evaporator with a plurality of heat exchanger plates which are stacked above one another, especially for a drive train of a motor vehicle, rail vehicle or a ship for example, comprising an internal combustion engine and a steam motor, with the heat of a hot medium such as a hot exhaust air flow, hot charge air, coolant, cooling agent or an oil of the internal combustion engine or a further unit provided in the drive train such as a vehicle air-conditioning system being used in the evaporator for generating the steam for the steam motor. The present invention is not limited to the application in a mobile drive train, but stationary drive trains such as in industrial applications or block-type thermal power stations can also be arranged accordingly.

Heat exchanger plates or evaporators for utilising the waste heat in a drive train, especially a drive train for a motor vehicle with an internal combustion engine to which the present invention relates according to one embodiment, have long been known. The heat contained in an exhaust gas flow of the internal combustion engine is used for evaporating and/or superheating a working medium, and the vaporous working medium is then expanded in an expansion machine, i.e. a piston engine, turbine or screw machine, under the release of mechanical power and is thereafter supplied to the evaporator again.

The utilisation of the exhaust gas heat of the recirculated exhaust gas flow of modern diesel engines is especially advantageous, but also of petrol engines because in this case the offered heat is available at a high temperature level. At the same time, the cooling system of the vehicle is relieved because the heat flow of the recirculated exhaust gas is decoupled from the cooling system and is used in the evaporation circuit process for generating useful power. It is simultaneously or alternatively advantageous to use the residual exhaust gas flow which until now flowed out from the rear muffler to the ambient environment in an unused manner for preheating, evaporation and/or superheating a working medium.

A further heat source which can be used at least for preheating, partial evaporation or even complete evaporation of the working medium in such a drive train is the heat contained in the coolant of a cooling circuit of the motor vehicle or the internal combustion engine. Further heat sources are obtained by exhaust gas recirculation and charge air cooling of vehicle engines and intermediate cooling in multi-step charging of the internal combustion engine. A separate burner unit can additionally or alternatively also be provided, or the heat of other heat sources in the drive train, especially the vehicle drive train, can be used such as engine oil, gear oil or hydraulic oil and electronic components, electric motors, generators or batteries that are provided there.

The mechanical power generated in the expansion machine from waste heat can be utilised in the drive train, either for driving auxiliary units or an electric generator. It is also possible to use the drive power directly driving the motor vehicle, which means for traction, in order to thereby provide the internal combustion engine with a more compact size, to reduce fuel consumption or provide more drive power.

Various requirements are placed on the heat exchanger plates or the evaporators in the mentioned fields of application. On the one hand, they should offer high efficiency and work reliably. On the other hand, they should be produced at lower cost and have a low overall volume and a low weight. Finally, the problem arises during use in the exhaust gas flow of an internal combustion engine that the volume flow of the exhaust gas will vary extremely during operation of the internal combustion engine and is further subject to temperature fluctuations. The exchanger plate or evaporator must be capable of securely managing such fluctuations in volume flow and temperature and securely ensuring the desired evaporation of the working medium in any possible state.

It has now been seen in practice that the heat exchanger plates or evaporators with comparatively long flow channels for the medium to be evaporated which are provided in a relatively small way in their flow cross-section due to the limited available space tends towards spitting. During the spitting phenomenon, there is no continuous flow through the heat exchanger plates or the evaporator with the working medium to be evaporated. Instead, the working medium exits the evaporator or the flow channels of the heat exchanger plates in gushes in a partly fluid, partly superheated state of aggregation. This discontinuous phenomenon can occur within a heat exchanger plate, but also in several plates of an evaporator which are switched in parallel. This phenomenon is caused in such a way that a vapour bubble is formed in a region of the flow channels which blocks the flow of as yet unevaporated working medium in this area. This leads to an evading flow of the as yet unevaporated working medium in the region outside of this area in the flow channel with the vapour bubble. The relatively enlarged volume flow by the evading flow in the areas outside of the vapour bubble leads to a relative cooling of the evading area, which consequently leads to the effect that fluid working medium is ejected, the vapour bubble will continue to grow and the problem of the blockage is exacerbated. Once the vapour bubble collapses at a later point in time, there will be a sudden renewed flow of as yet unevaporated working medium through the area formerly occupied by the vapour bubble, leading to a sudden evaporation. This non-steady behaviour simultaneously leads to extreme temperature change stress of the materials within the evaporator and thereby to a drastic reduction in the service life.

If a working medium flow to be evaporated flows through several heat exchanger plates in parallel, this inhomogeneity and also instability problem will exacerbate. If the evaporation starts earlier in a first plate than in a second plate, the pressure loss will rise strongly in said first place as a result of the commencing evaporation, leading to a reduction of the working medium throughput in said plate and therefore to a further amplification in the evaporation. If the working medium heat pump conveys an approximately constant working medium mass flow, the working medium throughput in the second plate will increase simultaneously, which thus renders evaporation there more difficult or even entirely impossible. Consequently, the first plate will provide strongly superheated steam and the second plate partly evaporated or subcooled fluid working medium at the plate outlet.

If the flow channels are now provided with an especially large cross-section for remedying this situation and preventing a blockage by a vapour bubble, this will inevitably lead to a comparatively short length of the flow channels as a result of the limited available overall space, which on the one hand has a negative effect concerning the desired heat input into the medium to be evaporated and leads to the likelihood on the other hand that in operating states with very low mass flow rates there will be an unequal distribution of the medium to be evaporated within the flow channels.

Reference is made to the following documents concerning the published state of the art:
U.S. Pat. No. 4,665,975 A
DE 10 2006 013 503 A1
DE 30 28 394 A1
DE 10 2006 031 676 A1.

A heat exchanger plate with parallel meander-like inflow channels are known from U.S. Pat. No. 4,665,975 A, to which evaporation channels are connected arranged in the longitudinal direction. Flow channels of a comparatively large cross-section which extend in the transverse direction are provided for distribution among the various evaporation channels.

The present invention is based on the object of providing a heat exchanger plate or an evaporator with a plurality of such heat exchanger plates which fulfil the mentioned requirements, ensure optimal heat transfer to the working medium to be evaporated and simultaneously securely prevent the aforementioned problem of blockage by vapour bubbles.

The object in accordance with the invention is achieved by a heat exchanger plate according to claim 1. The dependent claims describe advantageous embodiments and an evaporator with a plurality of such heat exchanger plates.

The heat exchanger plate in accordance with the invention for an evaporator has a longitudinal axis and a transverse axis, with the transverse axis being disposed perpendicularly or substantially perpendicularly to the longitudinal axis. Furthermore, at least one flow channel is provided for the medium (working medium) to be evaporated, which flow channel extends substantially predominantly in the direction of the longitudinal axis of the heat exchanger plate through a heat supply region of the heat exchanger plate and conducts the medium to be evaporated. Several such flow channels are provided in an especially advantageous manner to extend at least predominantly in the direction of the longitudinal axis of the heat exchanger plate, through which the medium to be evaporated flows simultaneously under absorption of heat. Extending at least predominantly in the direction of the longitudinal axis shall mean that not only straight flow channels which extend precisely in the direction of the longitudinal axis can be provided, but also flow channels which in their progression have a certain section of flow guidance in the direction of the transverse axis or obliquely in relation thereto, e.g. by short webs or the like. However, the main direction of flow exists in the direction of the longitudinal axis and the through-flow pressure loss in the longitudinal direction is considerably lower than in the transverse direction insofar as flow channels are provided adjacent to one another—as will be explained below—which enable an exchange of medium to be evaporated among each other, with such exchange then usually occurring in the direction of the transverse axis or obliquely in relation thereto. Reference is made below only to the flow channel extending in the direction of the longitudinal axis for the sake of simplicity without confirming each time again that certain deviations in direction are permissible.

At least one inlet is provided for the medium to be evaporated, which inlet is in a flow-conducting connection with the at least one flow channel extending in the direction of the longitudinal axis of the heat exchanger plate, so that the medium to be evaporated which flows through the inlet flows successively, but not directly successively as will be explained below, through the at least one flow channel or the plurality of flow channels in the direction of the longitudinal axis of the heat exchanger plate.

At least one meandering inflow channel is provided in accordance with the invention in the direction of the longitudinal axis between the inlet and the at least one flow channel extending in the direction of the longitudinal axis, which inflow channel is in a flow-conducting connection with the inlet and also in a flow-conducting connection with the at least one flow channel, and therefore conducts the medium to be evaporated which flows from the inlet to the at least one flow channel in an alternating fashion along the transverse axis and simultaneously in the direction of the at least one flow channel. The meandering inflow channel is formed by a plurality of webs disposed on the heat exchanger plate or a base plate which forms the bottom or top of the inflow channel and of the at least one flow channel arranged in the direction of the longitudinal axis, said webs running in the direction of the transverse axis. The inflow channel is divided between the webs into individual sub-channels by means of a plurality of plates extending in the direction of the transverse axis. This subdivision into sub-channels can either enable a transverse flow or secondary flow perpendicular to the main flow direction, as will be explained below in closer detail, in that the plates are provided with openings, or the individual sub-channels can be sealed against one another in that plates without openings are provided.

Accordingly, there are two mutually adjacent areas on the heat exchanger plate in accordance with the invention with different main flow directions of the medium to be evaporated. Whereas the main flow direction extends in the direction of the transverse axis in the meandering inflow channel, it extends in the at least one inflow channel which is directly or indirectly adjacent to the inflow channel in the direction of the longitudinal axis. When the heat supply via the heat exchanger plate for the evaporation of the medium to be evaporated is present within the inflow channel exclusively or substantially in the liquid state and vapour bubbles will only occur when said medium has already left this inflow channel and is located in the at least one flow channel which extends in the direction of the longitudinal axis of the heat exchanger plate, the flow cross-section for the medium to be evaporated in the inflow channel can be provided with a substantially smaller configuration than in the following at least one flow channel arranged in the direction of the longitudinal axis or than the total cross-section of all adjacently arranged flow channels extending in the direction of the longitudinal axis, through which the medium to be evaporated will flow simultaneously, which means that the heat exchanger plate can be arranged on the one side in an extremely compact manner in combination with a relatively long flow channel for the medium to be a evaporated and on the other side in the area in which vapour bubbles will form such a large flow cross-section is made available to the medium to be evaporated that a blockage of the entire heat exchanger plate or the entire flow cross-section available for the flow will be prevented. The evaporator will therefore no longer be able to spit.

The individual flow channels which are arranged in the direction of the longitudinal axis are delimited from one another in an especially advantageous manner by plates extending in the direction of the longitudinal axis. In accordance with a first embodiment, the individual flow channels disposed adjacent to one another are sealed from one another by the plates. In accordance with a second embodiment, the plates are provided with openings so that a transverse flow of medium to be evaporated can occur between the individual flow channels. It is ensured in the first case that any vapour bubble that is forming is unable to expand to adjacent flow channels. According to the second embodiment, it can be achieved at best depending on the available flow cross-section of every single flow channel and the maximum volume flow of medium to be conducted that there will not be any complete blockage of an individual flow channel by a vapour bubble.

The inflow channel can also be subdivided into individual sub-channels by plates, which will then especially extend in the direction of the transverse axis. Both embodiments are also possible in this case too, plates with openings in order to enable transverse flow or secondary flow perpendicular to the main flow direction and plates without openings which seal the individual sub-channels against one another.

When the medium to be evaporated flows out of the inflow channel, it should be distributed as evenly as possible for optimal evaporation over the entire flow cross-section of the flow channel arranged in the direction of the longitudinal axis of the heat exchanger plate or over all adjacently arranged flow channels extending in the longitudinal direction of the heat exchanger plate. This can be achieved according to an advantageous embodiment in such a way that a transverse distribution device for the flow is provided between the meandering inflow channel and the at least one flow channel extending in the direction of the longitudinal axis, which transverse distribution device compensates pressure losses caused by the length of the flow path between the outlet from the inflow channel and the various positions of the inlet into the at least one flow channel or the various inlets of the various flow channels. The transverse distribution device for the flow increases the flow resistance on the comparatively short distances between the outlet of the medium to be evaporated from the inflow channel and the entrance into the at least one flow channel arranged in the longitudinal direction in comparison with the comparatively longer distances between said outlet and entrance points positioned further away. Such a transverse distribution device for the flow can also be provided which sets the flow resistance on the individual paths to be covered by the medium to be evaporated from the outlet and the individual entrance points in such a way that uneven heat supply via the heat exchange of plates is compensated.

In accordance with a first embodiment, the pressure loss compensation caused by the length of the flow path can be achieved by plates provided in the direction of the longitudinal axis between the meandering inflow channel and the at least one flow channel extending in the direction of the longitudinal axis, which plates extend in the direction of the transverse axis and conduct the medium to be evaporated from the inflow channel in the direction towards the at least one fluid channel extending in the direction of the longitudinal axis. The plates comprise openings which provide a comparatively small overall flow cross-section for the medium to be evaporated in the direction of the longitudinal axis and therefore produce a comparatively higher flow resistance in the direction of the longitudinal axis than in the direction of the transverse axis. The number of the plates arranged successively in the direction of the longitudinal axis is arranged in a varying manner over the width of the heat exchanger plate, which means in the direction of the transverse axis, with the comparatively largest number of plates being arranged behind one another on the width section in which the entrance of the medium to be evaporated is provided into the successively arranged plates, and the number decreases with increasing distance from the entrance in the direction of the transverse axis. It is understood that the transverse distribution device for the flow can also be arranged differently, e.g. by adapting the individual flow channels which are especially arranged in the plates between the outlet of the medium to be evaporated from the inflow channel and the inlet or the various positions of the inlet into the at least one flow channel arranged in the direction of the longitudinal axis. As a result, individual flow channel contours can be provided with a smaller cross-section and others with a larger cross-section, or a flow channel will be deflected more often than the other one.

An alternative or additional measure for compensating pressure losses caused by the length of the flow path provides a throttling point in the direction of the longitudinal axis between the meandering inflow channel and the at least one flow channel extending in the direction of the longitudinal axis, which throttling point is provided over the entire width of the at least one flow channel extending in the direction of the longitudinal axis and causes the backing up of the medium to be evaporated over the entire width of the at least one flow channel extending in the direction of the longitudinal axis. Said backing up is so strong that the pressure loss via the throttling point—before the medium to be evaporated enters into the at least one flow channel extending in the direction of the longitudinal axis—far exceeds the various pressure losses caused by the length of the flow path before the throttling point.

The throttling point can be arranged for example by one or a plurality of webs which extend in the direction of the transverse axis all with an angle of less than 90° in relation to the transverse axis and which comprise or delimit at least one throttling opening. The web or the plurality of webs can delimit the throttling opening for example jointly with a base plate of the heat exchanger plate which forms the bottom or top of the inflow channel and the at least one flow channel arranged in the direction of the longitudinal axis.

The transverse distribution device for the flow can be arranged in such a way that a complete compensation of the pressure losses caused by the length of the flow path will occur. It is especially arranged in such a way that every fluid particle has the same temperature and/or the same speed when entering the at least one flow channel extending in the direction of the longitudinal axis. If the heat input into the medium to be evaporated is not constant over the area of the heat exchanger plate, then this can also lead to distinct imbalances in the pressure loss compensation by means of the transverse distribution device for the flow. This can also lead to dissymmetries in the transverse distribution device for the flow, especially when it is arranged—as will be described below in closer detail—with a plurality of flow-conducting plates.

A respective transverse distribution device for the flow can also be provided on the outlet side of the at least one flow channel extending in the longitudinal direction of the heat exchanger plate, relating to the flow of the medium to be evaporated, which transverse distribution device compensates pressure losses induced by the length of the flow path between the outlet from the at least one flow channel and an outlet of the heat exchanger plate for the partly or completely evaporated medium. This transverse distribution device for the flow can especially be formed by plates and/or a web, as described above.

The inflow channel is formed in an especially advantageous way by a plurality of webs located on the heat exchanger plate or the aforementioned base plate, which webs extend in the direction of the transverse axis and are arranged one after the other in the direction of the longitudinal axis starting in an alternating manner on one each of the two opposite sides of the heat exchanger plate and extending up to a predetermined distance to the respective other side. When seen in the direction of the flow of the medium to be evaporated through the at least one flow channel arranged in the direction of the longitudinal axis, the first web starts on the left side and extends in the direction of the transverse axis up to close to the right side of the heat exchanger plate. The second web then starts in the direction of the longitudinal axis at a distance behind the first web on the right side and extends in the direction of the transverse axis up to close to the left side. The third web would then start on the left side again etc. The meandering form as provided according to the invention would be achieved thereby. The rearmost web in the direction of the longitudinal axis can then terminate either in the area of one of the two sides of the heat exchanger plate. If deviating from the above the medium to be evaporated shall not exit at one side of the heat exchanger plate from the inflow channel, two laterally opposing partial webs are provided as the last web which expose an opening in the central region or even outside of the centre. It is not mandatory that the webs are respectively arranged on the one of the two opposite sides of the heat exchanger plate and then extend up one behind the other to a predetermined distance in relation to the respective other side as long as the meandering form can be achieved in a different way.

An evaporator in accordance with the invention for evaporating a fluid medium with a plurality of heat exchanger plates of the kind described herein which are stacked one above the other comprises at least one fluid inlet which is in flow-conducting connection with the inlets on the heat exchanger plates, a vapour outlet which is in flow-conducting connection with the flow channels on the heat exchanger plates which are arranged in the direction of the longitudinal axis and especially with the aforementioned outlets of said flow channels, and a channel conducting a heat carrier and/or any other heat source which supplies heat to the heat exchanger plates for evaporating the medium conducted through the inflow channels and the flow channels arranged in the direction of the longitudinal axis.

The guidance of the medium to be evaporated by means of the inflow channels and the flow channels arranged in the direction of the longitudinal axis occurs with the supply of heat in such a way that the medium to be evaporated is present in the inflow channels in an exclusively or nearly fluid state and in an at least partly vaporous state in the flow channels arranged in the direction of the longitudinal axis of the heat exchanger plates.

A drive train of a motor vehicle arranged in accordance with the invention with an internal combustion engine and a steam motor, wherein the invention can also be used in a drive train outside of a motor vehicle, comprises an evaporator arranged in accordance with the invention which is arranged in the exhaust gas flow of the internal combustion engine. The heat from the exhaust gas flow of the internal combustion engine is transferred by means of the heat exchanger plates to the vapour of the vapour circuit of the steam motor, so that the evaporator also needs to be arranged in the vapour circuit.

The invention will be explained below in closer detail by reference to exemplary embodiments shown in the drawings, wherein:

FIG. 1 shows a top view of a heat exchanger plate arranged in accordance with the invention with transverse dissolution devices for the flow before and behind the flow channels extending in the direction of the longitudinal axis;

FIG. 2 shows a top view of a heat exchanger plate arranged in accordance with the invention with a throttling point before the flow channels extending in the direction of the longitudinal axis;

FIG. 3 shows an advantageous configuration of a heat exchanger plate according to FIG. 1 by a layered joining of various components;

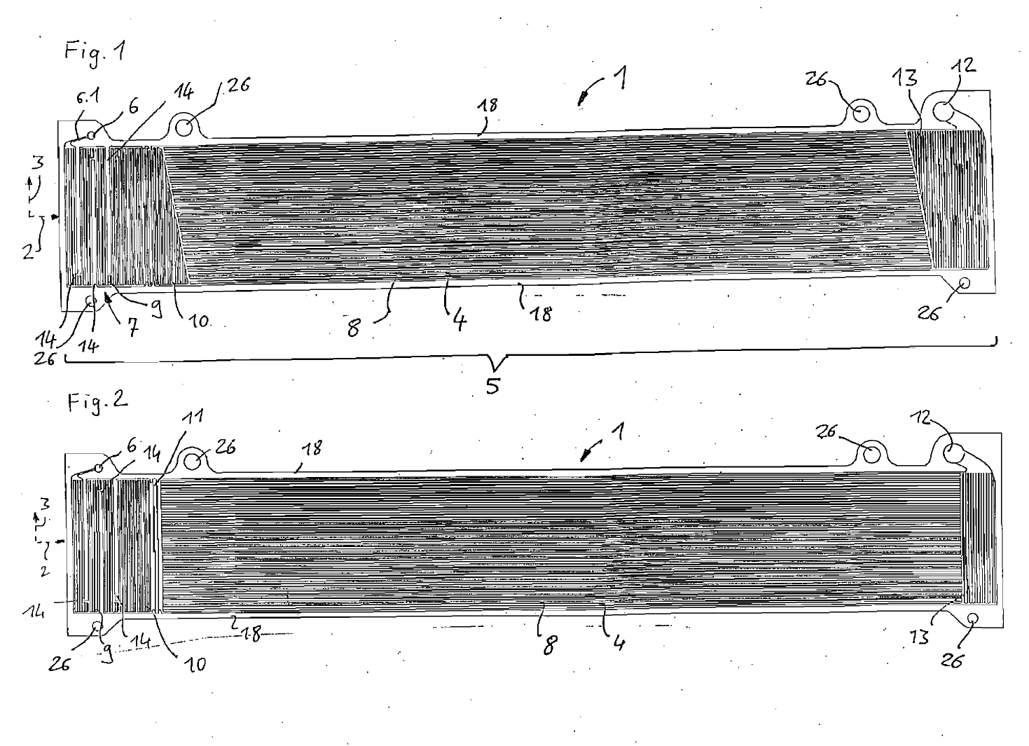

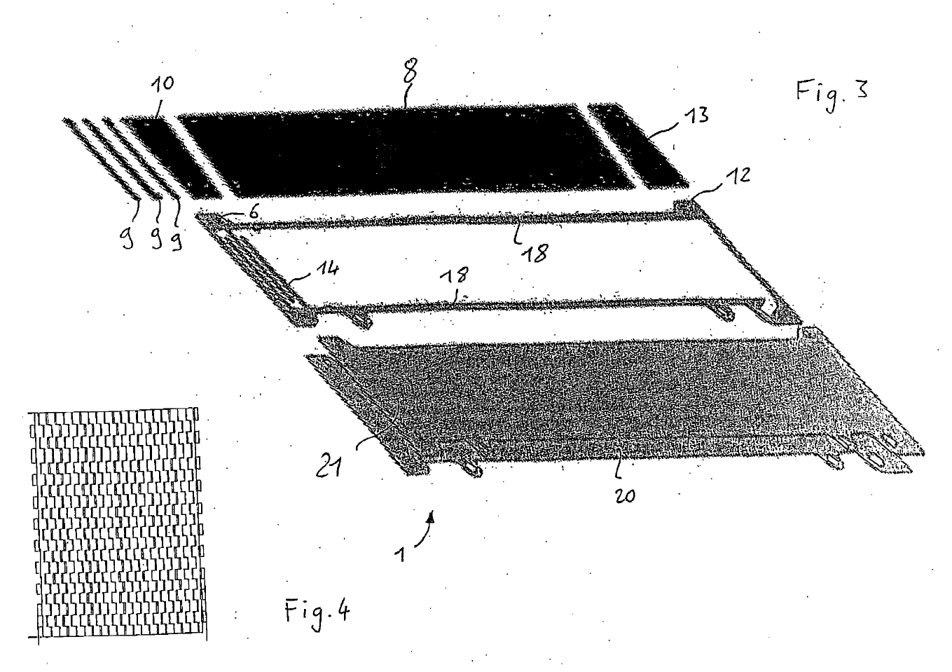

FIG. 4 shows a top view of a possible configuration of plates;

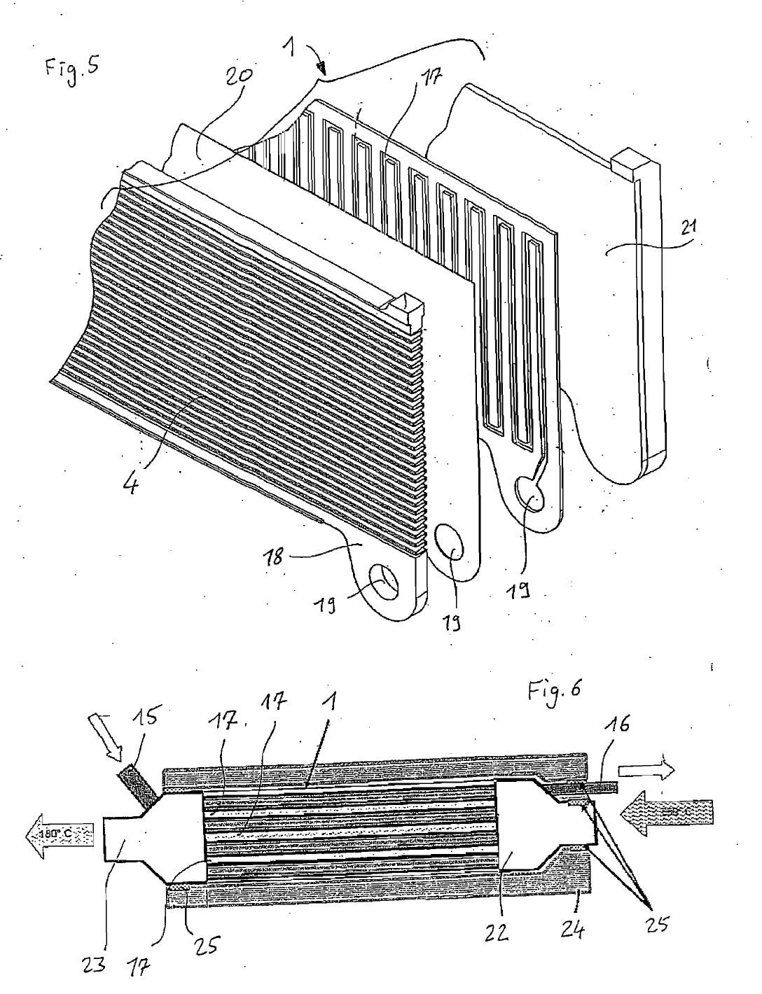

FIG. 5 shows an exemplary configuration of a heat exchanger plate in accordance with the invention with the side leading to the medium to be evaporated and the side which faces away therefrom and leads to the exhaust gas flow;

FIG. 6 shows a schematic view of an evaporator arranged in accordance with the invention with a plurality of respective heat exchanger plates;

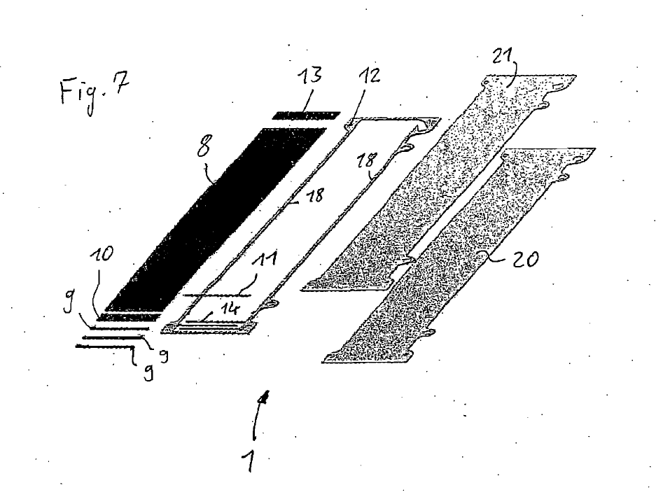

FIG. 7 shows a view in an allergy to FIG. 3 for a heat exchanger plate according to FIG. 2;

FIG. 8 shows an embodiment of a heat exchanger plate 1 which is modified in comparison with FIG. 1;

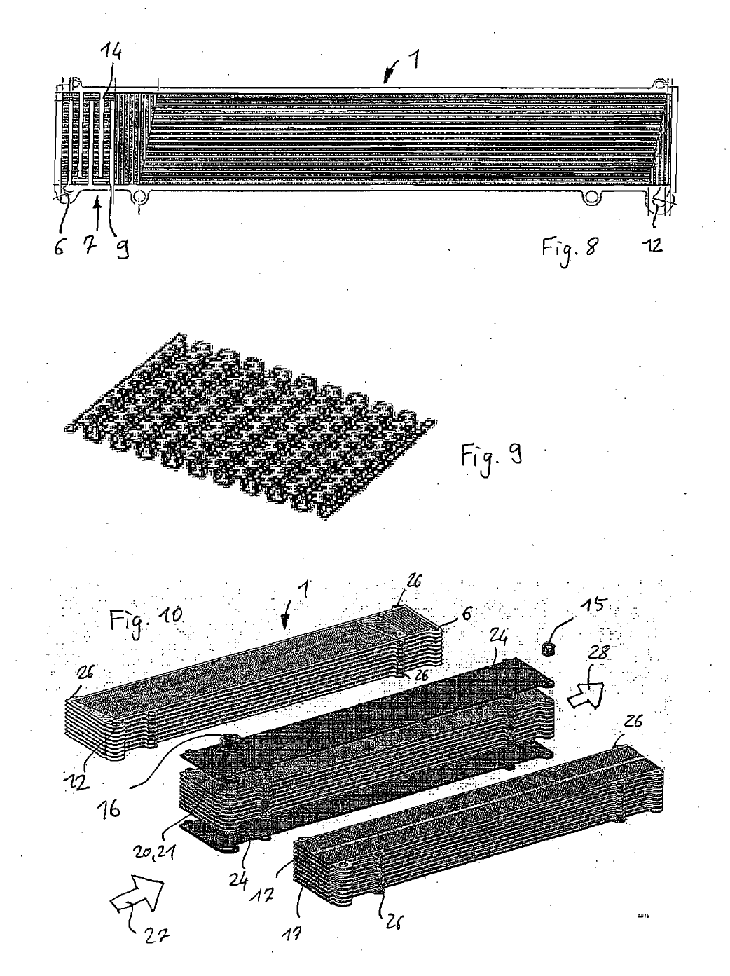

FIG. 9 shows an exemplary embodiment for a plate;

FIG. 10 shows an exploded view of an embodiment for an evaporator arranged in layers.

FIG. 1 shows a top view of a heated change plate 1 in accordance with the invention for an evaporator, with a plurality of such heat exchanger plates 1 usually being provided to be stacked one above the other in a respective evaporator. A longitudinal axis 2 and a transverse axis 3 are shown in the drawing for easier spatial allocation.

A plurality of flow channels 4 extend over the axially largest area of the heat exchanger plate 1 in the direction of the longitudinal axis 2, which conduct the medium to be evaporated. In the illustrated embodiment, the individual flow channels 4 are separated from one another by the plates 8. As is also shown, the flow channels 4 further extend over the entire width of the heat exchanger plate 1, as seen in the direction of view towards the longitudinal axis 2 and in the direction of flow of the medium to be evaporated in the flow channels 4. Webs 18 are further provided on the two lateral edges, which—as will be shown especially in FIG. 3—form the sidewalls of the flow-conducting region of the heat exchanger plate 1 and prevent that the medium to be evaporated will escape laterally from the heat exchanger plate 1.

An inlet 6 for the medium to be evaporated is provided on the first axial end. In the present case, the inlet 6 comprises at first a distributor borehole which extends through all stacked heat exchanger plates 1 (of which only one is shown in FIG. 1) and is in a flow-conducting connection in each heat exchanger plate 1 via a channel 6.1 with the actual inlet into an inflow channel 7 provided on each heat exchanger plate 1.

The inflow channel 7 extends from the first axial or face end of the exchanger plate 1 in the direction of the flow channels 4 arranged in the direction of the longitudinal axis 2. The inflow channel 7 is arranged in a meandering fashion in accordance with the invention; see the webs 14 extending in the direction of the transverse axis 3 which are arranged in the direction of the longitudinal axis 2 in an alternating fashion starting on one of the two opposite sides of the heat exchanger plate 1 and are arranged one behind the other extending to a predetermined distance in relation to the respective other side, so that the medium to be evaporated is respectively guided along every single entire web 14 in the direction of the transverse axis 3 until it flows through the distance at the lateral end of the web 14 in the direction of the longitudinal axis 2 to the next web 14. The webs 14 accordingly form a single meandering inflow channel 7, so that the entire medium to be evaporated which enters the heat exchanger plate 1 through the inlet 6 needs to flow through said single inflow channel 7 before it is distributed, as will be explained below in closer detail, among the different flow channels 4 which extend next to one another and are arranged in the direction of the longitudinal axis 2.

The flow channel of the inflow channel 7 is subdivided into individual partial channels by a plurality of plates 9 which extend in the direction of the transverse axis 3, as is illustrated in the drawings. The individual partial channels can be sealed against one another by the plates 9, with breakthroughs or recesses being provided in the region of the deflections which allow the desired meandering through-flow of the inflow channel 7. It is alternatively possible that the plates 9 comprise openings over the entire longitudinal extensions which connect the individual partial channels in a flow-conducting manner with each other. The same also applies to plates 8 which separate the flow channels 4 from one another which extend in the direction of the longitudinal axis 2.

The medium to be evaporated which exits through the space between the last plate 14 and the outside of the heat exchanger plate 1 out of the inflow channel 7 flows into an axial region between the inflow channel 7 and the channels 4 of the heat exchanger plate 1 which extend in the direction of the longitudinal axis 2, which heat exchanger plate is provided with a transverse distribution device for the flow for the purpose of optimal transverse distribution of the flow. In FIG. 1, the transverse distribution device for the flow comprises a plurality of plates 10 which extend in the direction of the transverse axis 3 and which are arranged one behind the other in the direction of the longitudinal axis 2 at a distance from one another. In the outer width section (shown at the bottom end of the heat exchanger plate 1 in FIG. 1) in which the medium to be evaporated flows out of the inflow channel 7, most plates 10 are arranged behind one another in the direction of the longitudinal axis 2, whereas on the other side of the heat exchanger plate 1 and therefore in the width section which is farthest away from the outlet of the inflow channel 7 the fewest plates 10 are arranged one behind the other in the direction of the longitudinal axis 2. This leads in the illustrated embodiment to a triangular outside shape of the plate region, with the angles of the outside shape able to be chosen on the basis of the running lengths and the correlating pressure losses in the through-flow with medium to be evaporated in the longitudinal direction and transverse direction and can be determined for example by simulation calculations or measurements. Typically chosen angles lie in the range of 0° to 90°, preferably in the range of 0° to 60°.

Since the plates 10 are provided with openings, with such plates also being designated as intersected plates, the flow resistance for the medium to be evaporated which flows along the plates 10, which means in the direction of the transverse axis 3, is lower for a medium which flows in the direction of the longitudinal axis 2 through the openings in the plates 10. However, such a flow for the medium to be evaporated is therefore enabled through the openings in the plates 10 and therefore along a comparatively short distance in the direction of the longitudinal axis 2. Since the medium to be evaporated needs to flow through more plates 10 the shorter the path, the flow resistance on this short path is respectively higher per unit of distance. It can be achieved thereby that the flow resistance on the comparatively shortest path substantially corresponds to the flow resistance on the comparatively longest path and simultaneously to the flow resistance on all parts which are in between with respect to their length. For example, the flow resistance for medium to be evaporated which flows out of the inflow channel 7 and straight in the direction of the longitudinal axis 2 into the flow channels 4 is as large as the one for the medium which flows out of the inflow channel 7 at first in the direction of the transverse axis 3 to the other side of the heat exchanger plate 1 and thereafter in the direction of the longitudinal axis 2 straight into the flow channels 4. As a result of this special arrangement of the plates 10, an even distribution of the medium to be evaporated which flows out of the inflow channel 7 can be achieved on all flow channels 4 extending in the direction of the longitudinal axis 2.

At the other axial end of the heat exchanger plate 1 or the flow channels 4 extending in the direction of the longitudinal axis 2, a respective second transverse distribution device of the flow is provided according to FIG. 1. In the present case, it comprises the plates 13 extending in the direction of the transverse axis 3. Said second transverse distribution device for the flow connects the plurality of flow channels 4 extending in the direction of the longitudinal axis 2 with an outlet 12 for the partly or completely evaporated medium. In the present case, the outlet 12 is arranged as a through-bore through the plurality of stacked heat exchanger plates 1 in order to join the evaporated medium flowing out of a heat exchanger plate 1 with the medium of the other plates and to then discharge the medium from the evaporator which comprises the respective heat exchanger plates.

The principle according to which the second transverse distribution device of the flow works corresponds precisely to the one of the first transverse distribution device for the flow in the direction of the longitudinal axis 2 between the inflow channel 7 and the flow channels 4. In this case too, the plates 13 form a flow path for the medium to be evaporated in the direction of the longitudinal axis 2 with a relatively higher flow resistance in comparison with the flow path extending through the plates 13 in the direction of the transverse axis 3. A comparatively higher number of plates 13 is provided in the direction of the longitudinal axis 2 in the width section in which the outlet 12 is provided or connected to the plate 30 (in the present case this is the uppermost width section shown in FIG. 1). The width section which is farthest away from the outlet 12 has the lowest number of plates in the direction of the longitudinal axis 2 (see the lowermost width section in FIG. 1). As a result, the flow resistance for the entire evaporated medium which flows out of the plurality of flow channels 4 and into the outlet 12 is substantially the same irrespective of the length of the distance covered by this evaporated medium.

Within the terms of production with a low amount of rejects, the plates 10 and the plates 13 can be produced at first as a common field of plates and thereafter be separated from one another. This especially occurs by an oblique cut, so that the angle—relating to the direction of the longitudinal axis 2 in the direction of flow—corresponds at the rear end of the field with the plates 10 to the angle at the beginning of the field with the plates 13. In order to then achieve the desired varying number of plates 10, 13 over the width of the heat exchanger plate 1 with respect to the outlet of the inflow channel 7 or the inflow into the outlet 12, the outlet 12 is arranged on the opposite side like the outlet from the inflow channel 7.

FIG. 1 shows further that the plates 9 in the inflow channel are arranged in the form of a plurality of integral fields of plates with a respective plurality of plates 9, with the L-shape of the fields of plates fully filling the intermediate space between 2 adjacent webs 14 of the inflow channel 7 and the lateral distance between one respective web 14 and the lateral end or, in this case, the web 18 of the heat exchanger plate 1 which forms the lateral wall.

The heat exchanger, which can especially be present in fluid or gaseous form, especially the exhaust gas of an internal combustion engine, flows on the rear side of the illustrated heat exchanger plate 1 or through a further heat exchanger plate provided on the rear side of the illustrated heat exchanger plate 1, which further heat exchanger plate can be adjusted to the type of the heat carrier depending on its configuration. The heat exchanger advantageously flows in a counter-current to the medium to be evaporated, which means in the illustration as shown in FIG. 1 from the right face side to the left face side of the heat exchanger plate 1. It is understood that other relative flows are possible, e.g. in a co-current flow or in cross flow, with the latter especially occurring by a meandering flow conduction of the heat carrier.

In the illustrated embodiment, no passage or pass-through is necessary for the heat carrier in the heat exchanger plate 1 as shown in FIG. 1. The illustrated boreholes 26 are rather used for the precise alignment of the individual heat exchanger plates 1, e.g. via pins guided through the boreholes 26. It would alternatively also be possible to provide openings or channels for the heat carrier in the heat exchanger plates 1, either for distributing the heat carrier to the different levels of the evaporator or conducting the heat carrier by means of the same heat exchanger plate 1 which also conducts the medium to be evaporated.

FIG. 5 shows an example for such a borehole 19 which also extends through the plane or plate which conducts the medium to be evaporated (see flow channels 4 which extend predominantly in the direction of the longitudinal axis). The heat exchanger plate 1 shown in FIG. 5 is arranged in layers, comprising 4 plates which are stacked one above the other in order to form a plane for flow conduction of the fluid to be evaporated and a plane for flow conduction of the carrier. The meandering conduction of flow for the heat carrier which enters the heat exchanger plate 1 through the borehole 19 is especially suitable for an evaporator which utilises hot coolant or hot oils as a heat source. The meandering channel for the heat carrier is arranged on one side of a base plate 20, which faces away from the side which conducts the medium to be evaporated into the flow channels 4 arranged in the direction of the longitudinal axis. As a result of the meandering conduction of flow of the heat carrier with the conduction of flow in the direction of the longitudinal axis of the medium to be evaporated, a cross-flow heat exchanger is formed. The chosen layered configuration with the plate conducting the medium to be evaporated, i.e. the base plate 20, the plate conducting the heat carrier and the cover plate 21 which are stacked one above the other in a large number, allows an especially simple and cost-effective production.

Deviating from the indicated illustration, it is obviously also possible to choose the conduction of the fluids which are in heat-exchanging connection in such a way that a co-current heat exchanger or a counter-current heat exchanger or random mixed forms are formed.

With reference to FIG. 1 again, the heat supply area 5, in which the medium to be evaporated is supplied with heat from the heat carrier, extends both over the entire inflow channel 7 and also the (at least one) flow channel 4, especially further also the outlet area with the plates 13, advantageously over the entire extension of the heat exchanger plate 1 in the direction of the longitudinal axis 2 and/or the transverse axis 3.

Instead of the embodiment as shown in FIG. 1, the heat exchanger plate 1 could also comprise only one single transverse distribution device of the flow with a number of plates 10, 13 which vary over the width. It could be provided with the plates 10 or 13 according to the two illustrated transverse distribution devices for the flow, with only one of the two, especially the one in the direction of flow behind the flow channels 4, being omitted. It would alternatively also be possible to compensate pressure losses caused by the length of the flow paths with one single transverse distribution device of the flow, both on the inlet side and also the outlet side of the flow channels 4 extending in the direction of the longitudinal axis 2. Such a transverse distribution device for the flow would comprise a respectively more oblique outlet out of the field of plates with the plates 10 or alternatively a respectively more oblique inlet into the field of plates with the plates 13, or a field of plates with oblique outlet and oblique inlet, or other measures within the respective field of plates, especially by reducing the openings for the flow in the direction of the longitudinal axis 2.

FIG. 2 shows an embodiment of a heat exchanger plate 1 which is similar to the one according to FIG. 1, with the same reference numerals being used for the same components. One difference is that the arrangement of the transverse distribution device for the flow before the flow channels 4. It comprises a throttling point 11 which is formed by a web which extends in the direction of the transverse axis 3. Said throttling point 11 causes a backing up of the medium to be evaporated before it enters the flow channels 4. Said backing up produces a distribution of the medium to be evaporated over the entire width of the heat exchanger plate 1 in the direction of the transverse axis 3. Furthermore, the transverse distribution device for the flow is modified in the direction of flow behind the flow channels 4 in comparison with FIG. 1. It is especially advantageous when the plates 8 which extend in the direction of the longitudinal axis 2 and form the plates 8 rest in a flush manner on the throttling point 11 or the web provided for this purpose, so that no gap is formed and no transverse exchange of the flow can occur between the throttling point 11 and the flow channels 4.

It is understood that the throttling point 11 could also extend at an angle which is smaller than 90° in relation to the transverse axis 3 and can therefore be similarly positioned in an oblique manner as the axial end of the field with the plates 10 according to FIG. 1.

In the illustrated embodiment, plates 10 which also extend in the direction of the transverse axis are provided before the throttling point 11, but in this case with the same number of plates 10 in the direction of the longitudinal axis 2 over the entire width of the heat exchanger plate 1. In this case too, plates could also be provided here too as in FIG. 1.

Plates 13 are also provided in the direction of flow behind the flow channels 4, which plates extend in the direction of the transverse axis 3. The number of plates 13 arranged behind one another is also constant in this case over the entire width of the heat exchanger plate 1. An embodiment as shown in FIG. 1 would also be possible as an alternative for example.

Although FIGS. 1 and 2 show different embodiments for transverse distribution devices for the flow, further embodiments are possible. For example, the axial ends of the fields of plates can be delimited by several lines, especially two thereof, extending at an angle with respect to one another, or also by an arc shape. Furthermore, other measures with the same effect are possible, e.g. providing sponges or other structures that influence the flow resistance.

FIG. 3 shows another possible layered configuration of a heat exchanger plate 1 arranged in accordance with the invention. It comprises a base plate 20 on which the webs 18 and the webs 14 can be placed. As is illustrated, the webs 18 and the webs 14 can also be provided with an integral configuration, especially in the form of an integral structural plate. The plates 9, 10, 8 and 13 can then be placed in the space enclosed by the webs 14, 18, before a further plate (the cover plate 21) is placed thereon from above in order to seal the space with the plates 9, 10, 8, 13 together with the webs 18. The plates 9, 10, 8 and 13 form the configuration in the inserted state as shown in FIG. 1.

In an especially advantageous manner, the structural plate with the webs 14 and 18 and the base plate 20 and the cover plate 21 can be soldered together or joined together by other material joining measures. For example, solder foils can be placed between the structural plate and the base plate 20 or the cover plate 21, or the required solder is made available by other known methods at the respective points. It is understood that non-material mounting of the aforementioned plates is also possible.

FIG. 7 shows the respective components in an analogous representation in order to provide a configuration according to FIG. 2 with the throttling point 11 between the plates 10 and the plates 8; see the additionally inserted web which forms the throttling point 11 together with the base plate and/or the cover plate 21.

The medium to be evaporated is guided between the base plate 20 and the cover plate 21. The heat carrier whose heat is used for evaporating the medium to be evaporated can then be conducted on at least one of the sides or both sides facing away, which in this case is beneath the base plate 20 and above the cover plate 21, especially in a channel 17 as shown in FIGS. 5 and 6. It would alternatively also be possible to heat one or both plates (base plate 20 and cover plate 21) by another matter, especially electrically or by induction, or to provide other measures for supplying heat to the medium to be evaporated.

FIG. 4 shows an example for a field of plates in a top view, as can be used in individual plates or all plates 9, 10, 8, 13 as discussed herein. The plates therefore have a meandering shape in the direction of the main flow, which means in the plates 9, 10 and 13 as seen in the direction of the transverse axis 3 and in the plates 8 as seen in the direction of the longitudinal axis 2, the deflection effect of which could also be achieved with respect to the through-flow with straight plates with webs. Respective arc shapes or even straight plates can alternatively be used. The plates can be intersected or non-intersected, which means they can comprise openings for a secondary flow transversely to the direction of main flow, or the individual flow channels of the main flow can seal each other.

FIG. 6 shows an embodiment of an evaporator arranged in accordance with the invention with a plurality of heat exchanger plates 1 which are stacked above one another. It comprises a fluid inlet 15 and a vapour outlet 16. Furthermore, an inlet 22 for a heat carrier and an outlet 23 for the same are provided. The inlet 22 for the heat carrier, especially for exhaust gas of an internal combustion engine, distributes the heat carrier among all heat-carrier-conducting channels 17 of the heat exchanger plates 1. The outlet 23 collects the heat carrier once it has flown through the channel 17 and discharges it from the evaporator at a respectively reduced temperature. The medium to be evaporated which is introduced into the evaporator via the fluid inlet 15 is distributed among the various heat exchanger plates 1, flows there through the aforementioned channels, is collected again and is discharged via the vapour outlet 16 out of the evaporator in the vaporous state. The various components are sealed off against the ambient environment by suitable seals 25 in a housing 24. It is possible for example to evacuate the housing 24 in order to achieve the best possible insulation against the ambient environment. Further insulating layers can also be inserted.

The conduction of the medium to be evaporated through the evaporator now occurs in such a way—with the heat supply being arranged accordingly—that the medium to be evaporated is present in the inflow channels of the various heat exchanger plates 1 (see FIGS. 1 and 2) in the fluid state and the first vapour bubbles will only occur in the channels 4 extending in the direction of the longitudinal axis 2, i.e. in the phase transition region, in which the flow cross-section available for the medium to be evaporated is expanded considerably over the one of the inflow channels 7.

FIG. 8 shows a further embodiment according to the one as shown in FIG. 1. In the present case, the meandering inflow channel 7 comprises five webs 14 however, which originate in an alternating fashion on the two sides of the heat exchanger plate 1. The plates 9 are also arranged in the entire meandering inflow channel 7 in the form of an integrated field of plates.

One example for a field of plates as can be used according to the present invention at the various points of the heat exchanger plate 1 is shown in FIG. 9. It is shown that the plates do not extend in a straight line but comprise comparatively short lateral webs.

FIG. 10 shows an exploded view of an especially cost-effective configuration of an evaporator arranged in accordance with the invention. A plurality of stacked and aligned heat exchanger plates 1 are shown in the upper region, according to those of FIG. 8. The plates on the exhaust side are shown in the bottom region for forming the heat-carrier-conducting channels 17. The inflow and the outflow of the exhaust gas occur on the face side (see arrows 27 and 28). The heat exchanger plates 1 and the plates on the exhaust gas side with the channels 17 are now inserted in an alternating fashion between the base plates 20 and the cover plates 21 and are introduced into the housing 24 in order to form a layered configuration. The medium to be evaporated flows via the fluid inlet 15 into the evaporator and via the vapour outlet 16 out of the evaporator which is arranged according to the counter-flow principle.

1-13. (canceled)

14. A heat exchanger plate for an evaporator;
with a longitudinal axis and a transverse axis, with the transverse axis being disposed perpendicularly or substantially perpendicularly to the longitudinal axis;
with at least one flow channel which extends in the direction of the longitudinal axis of the heat exchanger plate through a heat supply area of the heat exchanger plate and conducts the medium to be evaporated;
with an inlet for the medium to be evaporated, which inlet is in a flow-conducting connection with the at least one flow channel arranged in the direction of the longitudinal axis of the heat exchanger plate, with
a meandering inflow channel being provided in the direction of the longitudinal axis between the inlet and the at least one flow channel arranged in the direction of the longitudinal axis, which inflow channel is in a flow-conducting connection with the inlet and the at least one flow channel, and conducts the medium which flows out of the inlet to the at least one flow channel in an alternating manner along the transverse axis in the direction of the at least one flow channel, characterized in that
the meandering inflow channel is formed by a plurality of webs which are disposed on the heat exchanger plate or a base plate which forms the bottom or top of the inflow channel and the at least one flow channel arranged in the direction of the longitudinal axis, which webs extend in the direction of the transverse axis, and the inflow channel between the webs is subdivided into individual partial channels by a plurality of plates which extend in the direction of the transverse axis.

15. The heat exchanger plate according to claim 14, characterized in that a plurality of adjacently arranged flow channels are provided which extend in the direction of the longitudinal axis, conduct the medium to be evaporated and are in a flow-conducting connection with the meandering inflow channel in such a way that the medium to be evaporated flows from the inflow channel simultaneously parallel through the plurality of flow channels.

16. The heat exchanger plate according to claim 15, characterized in that the individual flow channels are delimited from one another by plates extending in the direction of the longitudinal axis, with the plates either sealing mutually adjacent flow channels from one another, or are provided with openings, especially slots, in order to enable a partial exchange of the medium to be evaporated which flows through the mutually adjacent flow channels.

17. The heat exchanger plate according to claim 14, characterized in that the inflow channel is subdivided into individual partial channels by plates which extend in the direction of the transverse axis, with the plates especially comprising openings which connect mutually adjacent partial channels in a flow-conducting manner with one another.

18. The heat exchanger plate according to claim 15, characterized in that the inflow channel is subdivided into individual partial channels by plates which extend in the direction of the transverse axis, with the plates especially comprising openings which connect mutually adjacent partial channels in a flow-conducting manner with one another.

19. The heat exchanger plate according to claim 16, characterized in that the inflow channel is subdivided into individual partial channels by plates which extend in the direction of the transverse axis, with the plates especially comprising openings which connect mutually adjacent partial channels in a flow-conducting manner with one another.

20. The heat exchanger plate according to claim 14, characterized in that a transverse distribution device for the flow is provided in the direction of the longitudinal axis between the meandering inflow channel and the at least one flow channel extending in the direction of the longitudinal axis, which transverse distribution device compensates pressure losses caused by the length of the flow path between the outlet from the inflow channel and the various positions of the inlet into the at least one flow channel and/or between the outlet from the inflow channel and the inlets of the various flow channels arranged next to one another.

21. The heat exchanger plate according to claim 15, characterized in that a transverse distribution device for the flow is provided in the direction of the longitudinal axis between the meandering inflow channel and the at least one flow channel extending in the direction of the longitudinal axis, which transverse distribution device compensates pressure losses caused by the length of the flow path between the outlet from the inflow channel and the various positions of the inlet into the at least one flow channel and/or between the outlet from the inflow channel and the inlets of the various flow channels arranged next to one another.

22. The heat exchanger plate according to claim 16, characterized in that a transverse distribution device for the flow is provided in the direction of the longitudinal axis between the meandering inflow channel and the at least one flow channel extending in the direction of the longitudinal axis, which transverse distribution device compensates pressure losses caused by the length of the flow path between the outlet from the inflow channel and the various positions of the inlet into the at least one flow channel and/or between the outlet from the inflow channel and the inlets of the various flow channels arranged next to one another.

23. The heat exchanger plate according to claim 17, characterized in that a transverse distribution device for the flow is provided in the direction of the longitudinal axis between the meandering inflow channel and the at least one flow channel extending in the direction of the longitudinal axis, which transverse distribution device compensates pressure losses caused by the length of the flow path between the outlet from the inflow channel and the various positions of the inlet into the at least one flow channel and/or between the outlet from the inflow channel and the inlets of the various flow channels arranged next to one another.

24. The heat exchanger plate according to claim 18, characterized in that a transverse distribution device for the flow is provided in the direction of the longitudinal axis between the meandering inflow channel and the at least one flow channel extending in the direction of the longitudinal axis, which transverse distribution device compensates pressure losses caused by the length of the flow path between the outlet from the inflow channel and the various positions of the inlet into the at least one flow channel and/or between the outlet from the inflow channel and the inlets of the various flow channels arranged next to one another.

25. The heat exchanger plate according to claim 19, characterized in that a transverse distribution device for the flow is provided in the direction of the longitudinal axis between the meandering inflow channel and the at least one flow channel extending in the direction of the longitudinal axis, which transverse distribution device compensates pressure losses caused by the length of the flow path between the outlet from the inflow channel and the various positions of the inlet into the at least one flow channel and/or between the outlet from the inflow channel and the inlets of the various flow channels arranged next to one another.

26. The heat exchanger plate according to claim 20, characterized in that a plurality of plates are arranged in the direction of the longitudinal axis between the meandering inflow channel and the at least one flow channel extending in the direction of the longitudinal axis, which plates are arranged one after the other in the direction of the longitudinal axis, extend in the direction of the transverse axis and conduct the medium to be evaporated to the at least one flow channel extending in the direction of the longitudinal axis, with the plates having openings which enable a flow of the medium to be evaporated in the direction of the longitudinal axis with comparatively higher flow resistance than in the direction of the transverse axis, and the number of the plates arranged one after the other in the direction of the longitudinal axis varying over the width of the heat exchanger plate in the direction of the transverse axis, with the comparatively largest number of plates one after the other being provided on the width section, especially at a lateral end, in which the inlet of the medium to be evaporated to the successively arranged plates is provided, and this number decreases with rising distance from the inlet in the direction of the transverse axis.

27. The heat exchanger plate according to claim 20, characterized in that a throttling point is provided in the direction of the longitudinal axis between the meandering inflow channel and the at least one flow channel extending in the direction of the longitudinal axis, which throttling point is provided over the entire width of the at least one flow channel extending in the direction of the longitudinal axis or all flow channels and causes the backing up of the medium to be evaporated over said entire width.

28. The heat exchanger plate according to claim 27, characterized in that the throttling point is formed by one web or a plurality thereof, extending in the direction of the transverse axis or obliquely in relation to the transverse axis at an angle of less than 90 degrees to the transverse axis and comprising or delimiting one or several throttle openings.

29. The heat exchanger plate according to claim 20, characterized in that an outlet for the partly or completely evaporated medium is provided, which outlet is in a flow-conducting connection with the at least one flow channel extending in the direction of the longitudinal axis, and a second transverse distribution device for the flow is provided between the flow channel and the outlet in the direction of the longitudinal axis, which transverse distribution device compensates pressure losses caused by the length of the flow path between the exit from the at least one flow channel and the outlet, especially in the form of a plurality of plates which are arranged one after the other in the direction of the longitudinal axis and extend in the direction of the transverse axis, which plates conduct the partly or fully evaporated medium in the direction of the outlet, with the plates having openings which enable a flow of the partly or fully evaporated medium in the direction of the longitudinal axis with a comparatively higher flow resistance than in the direction of the transverse axis, and the number of the plates arranged one after the other in the direction of the longitudinal axis varies over the width of the heat exchanger plate in the direction of the transverse axis, and the comparatively largest number of plates behind one another is provided on the width section in which the outlet is provided, and said number decreases with rising distance from the outlet in the direction of the transverse axis.

30. The heat exchanger plate according to claim 14, characterized in that the inflow channel is formed by a plurality of webs disposed on the heat exchanger plate, which webs extend in the direction of the transverse axis and are arranged one after the other in the direction of the longitudinal axis in an alternating fashion by starting on one of the two opposite sides of the heat exchanger plate and extending up to a predetermined distance to the respective other side behind one another, so that the medium to be evaporated is respectively conducted along each entire web in the direction of the transverse axis until it flows through the distance at the lateral end of the web in the direction of the longitudinal axis up to the next web.

31. The heat exchanger plate according to claim 17, characterized in that the plates in the inflow channel are subdivided into a plurality of integral fields of plates with a plurality of plates, and the fields of plates have an L-shape in a top view which fills the intermediate space between two adjacent webs of the inflow channel and the lateral distance.

32. The evaporator for evaporating a fluid medium with a plurality of stacked heat exchanger plates according to claim 14, comprising a fluid inlet which is in flow-conducting connection with the inlets on the heat exchanger plates;
with a vapour outlet which is in flow-conducting connection with the flow channels arranged in the direction of the longitudinal axis on the heat exchanger plates and especially with the outlets on the heat exchanger plates;
with a channel conducting a heat carrier and/or with any other heat source in order to supply heat from the heat carrier or the other heat source for evaporating the medium which is conducted by the same through the inflow channels and the flow channels arranged in the direction of the longitudinal axis;
characterized in that
the conduction of the medium to be evaporated by means of the inflow channels and the flow channels arranged in the direction of the longitudinal axis occurs with supply of heat in such a way that the medium to be evaporated is present in the inflow channels in a completely or substantially fluid state and is present in an at least partly vaporous state in the flow channels arranged in the direction of the longitudinal axis.

33. A drive train, especially a motor vehicle, comprising an internal combustion engine and a steam motor, with the internal combustion engine generating an exhaust gas flow, and the steam motor is arranged in a steam circuit, characterized in that an evaporator according to claim 25 is provided, with the exhaust gas flow as the heat carrier flowing through the channel conducting a heat carrier, and is supplied with medium of the steam circuit for the evaporation of the same by means of heat from the exhaust gas flow.
